(19) United States
(12) Patent Application Publication
(10) Pub. No.: US 2026/0367723 A1
(43) Pub. Date: Nov. 19, 2026

(54) TOUCHPAD

(71) Applicant: Lenovo Japan LLC, Tokyo (JP)

(72) Inventors: Kimio Kumada, Kanagawa (JP); Kazuyuki Kubota, Kanagawa (JP)

(73) Assignee: Lenovo Japan LLC, Tokyo (JP)

(21) Appl. No.: 19/451,069

(22) Filed: Jan. 16, 2026

(30) Foreign Application Priority Data
Mar. 11, 2025 (JP) 2025-038581

(51) Int. Cl. G06F 3/039; G06F 3/0354

(52) U.S. Cl. CPC G06F 3/0393; G06F 3/03547; G06F 2203/0339

(57) ABSTRACT

A touchpad includes: a base member; a sensor board capable of recognizing a contact position; a first tilting member configured to be tiltable about a first pivot point relative to the base member; a second tilting member configured to be tiltable about a second pivot point relative to the first tilting member in a first direction as viewed from the first pivot point in side view; an anti-slip portion of the first tilting member and the second tilting member for the base member; an elastic material biasing the first tilting member and the second tilting member to separate in a second direction opposite to the first direction in side view; and a switch configured between the first tilting member and either the second tilting member or the sensor board in the second direction as viewed from the first pivot point in side view.

### CROSS-REFERENCE TO RELATED APPLICATIONS

This application claims priority to Japanese Patent Application No. 2025-038581 filed on Mar. 11, 2025, the contents of which are hereby incorporated herein by reference in their entirety.

### TECHNICAL FIELD

The present invention relates to a touchpad that performs manual pointing operations.

### BACKGROUND

For example, a laptop personal computer (laptop PC) is provided with a touchpad as an alternative to a mouse. The touchpad is a type of pointing device that moves a cursor displayed on a display device in response to a touch operation with a fingertip. The touchpad is generally provided on the front side of the upper surface of the main body chassis, adjacent to a keyboard.

Regarding an input device equipped with such a touchpad, the present applicant has proposed a configuration enabling both touch and press operations in Japanese Unexamined Patent Application Publication No. 2018-060306.

In this configuration, a plurality of pseudo-button areas is set on a touch surface of the touchpad. By touching each pseudo-button area while pressing down on the touchpad, an input operation corresponding to the pseudo-button area is able to be performed. This touchpad has a sensor board that detects human hand contact on the upper surface thereof and a switch that is able to be switched on and off by pressing down on the sensor board. The switching of the switch provides a click sensation.

In the electronic apparatus described in Japanese Unexamined Patent Application Publication No. 2018-060306, a pointing stick is provided approximately at the center of the keyboard. The pseudo-button area near the keyboard on the touchpad is an operating area associated with the pointing stick.

Unlike operating the touchpad with an index finger, the pseudo-button area is often operated with the side of a thumb, making it not necessarily easy to apply force. It is preferable that the force required to press down varies depending on an area requiring manual operation, not limited to the area associated with the pointing stick, according to the specifications.

In view of the above problem, the present invention has been provided. It is an object of the present invention to provide a touchpad capable of varying the force required for pressing down according to an operating area.

### SUMMARY

To solve the above problem and achieve the object, the present invention provides a touchpad according to the first aspect of the present invention that is a touchpad, including: a base member; a sensor board capable of recognizing a contact position; a first tilting member configured to be tiltable about a first pivot point relative to the base member; a second tilting member configured to be tiltable about a second pivot point relative to the first tilting member in a first direction as viewed from the first pivot point in side view, the second tilting member fixed to the sensor board; an anti-slip portion of the first tilting member and the second tilting member for the base member; an elastic material biasing the first tilting member and the second tilting member to separate in a second direction opposite to the first direction in side view; and a switch configured between the first tilting member and either the second tilting member or the sensor board in the second direction as viewed from the first pivot point in side view.

The above-described aspect of present invention can vary the force required for pressing down according to an operating area by a configuration in which the first tilting member is tiltable about the first pivot point, the second tilting member is tiltable relative to the first tilting member about the second pivot point, and the switch is provided between the first tilting member and the second tilting member of the sensor board.

### BRIEF DESCRIPTION OF THE DRAWINGS

FIG. 1 is a perspective view of an electronic apparatus with a touchpad according to one or more embodiments of the present invention.

FIG. 2 is a plan view of the touchpad.

FIG. 3 is a bottom view of the touchpad.

FIG. 4 is a bottom view of the touchpad with the base plate removed.

FIG. 5 is an exploded perspective view of the touchpad.

FIG. 6 is a plan view of the base plate.

FIG. 7 is a plan view of a housing plate.

FIG. 8 is a perspective view of a pressure piece placement hole and the surrounding area thereof.

FIG. 9 is an enlarged perspective view of the front corner portion of a plate hole as seen from below.

FIG. 10 is a bottom view of a pusher plate.

FIG. 11 is an enlarged perspective view of the front corner portion of the pusher plate as seen from below.

FIG. 12 is a schematic cross-sectional side view of the touchpad: (a) is a view illustrating a non-operational state; (b) is a view illustrating a state where the front end vicinity is pressed down; (c) is a view illustrating a state where the rear end is pressed down; and (d) is a view illustrating a state where the touchpad is pressed down from above the first pivot point.

FIG. 13 is a graph of a force required for pressing, measured on an actual touchpad of one or more embodiments.

### DETAILED DESCRIPTION OF THE INVENTION

The following describes the details of a touchpad according to the present invention with reference to appended drawings. The present invention, however, is not limited to these embodiments.

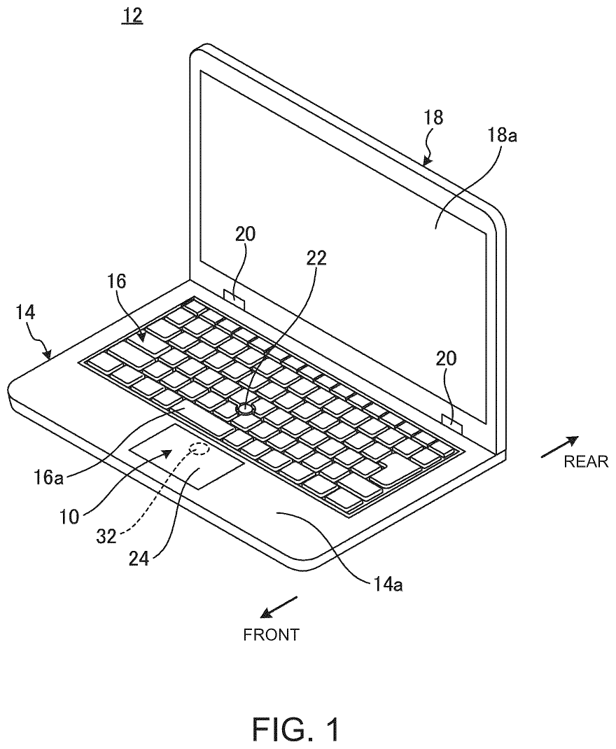

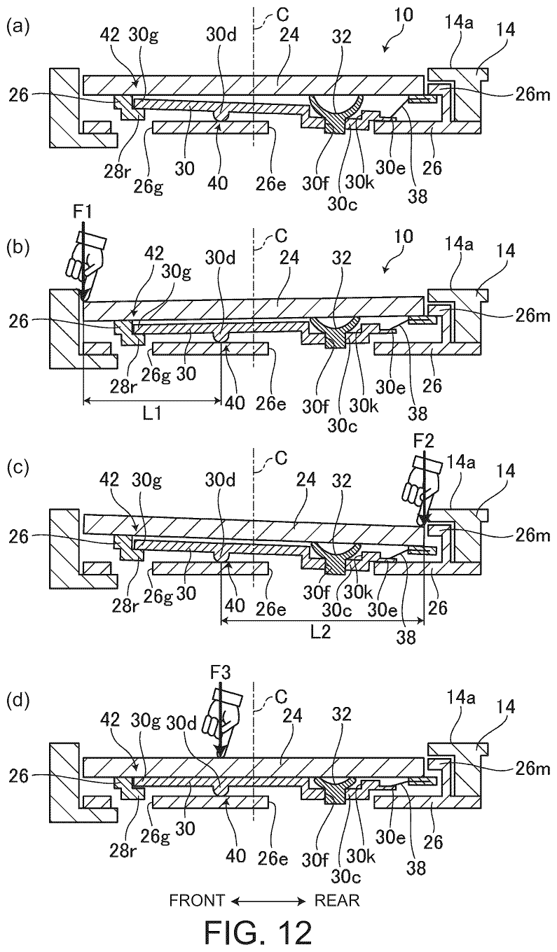

FIG. 1 is a perspective view of an electronic apparatus 12 equipped with a touchpad 10 according to one or more embodiments of the present invention. In the following description of the touchpad 10, the side closer to a keyboard 16 is designated as rear (second direction), the opposite side thereof as front (first direction), the side of a sensor board 24 as top, and the opposite side as bottom. Furthermore, the clockwise and counterclockwise directions of rotation are based on the view from the right side (FIG. 12).

As illustrated in FIG. 1, the electronic apparatus 12 is a laptop PC including a main body chassis 14 having the touchpad 10 and the keyboard 16, and a display chassis 18 having a display 18a such as a liquid crystal display. The display chassis 18 is connected to the main body chassis 14 via a pair of left and right hinges 20, 20, allowing the display chassis 18 to open and close. Although the touchpad 10 is an integrated type within the electronic apparatus 12, an external type may also be used.

Inside the main body chassis 14, there are housed various electronic components such as a printed circuit board, an arithmetic processing unit, a storage, a memory, and a battery, which are not illustrated. The touchpad and the keyboard 16 are arranged front-to-rear on the upper surface of the main body chassis 14. A pointing stick 22 is provided approximately at the center of the keyboard 16.

The pointing stick 22 is a type of pointing device that moves the cursor displayed on the display 18a in a tilt direction. The pointing stick 22 has a small cylindrical shape and is provided approximately at the center of the keyboard 16, for example, midway between the G key, H key, and B key. The pointing stick 22 is primarily used to move the cursor by performing a tilt operation with the index or middle finger. For point-and-click operations, the touchpad 10 is primarily pressed down with the thumb.

Subsequently, the touchpad 10 is described. The touchpad 10 is provided approximately at the center of the palm rest area on the front side of the keyboard 16 on the upper surface of the main body chassis 14. Specifically, the touchpad 10 is provided adjacent to the keyboard 16 in the front-to-rear direction. The lateral center of the touchpad 10 is substantially aligned with the pointing stick 22. The touchpad 10 is a slightly elongated rectangle, with the front-to-rear width thereof occupying nearly the entire width of the palm rest area. The size of the touchpad 10 in planar view is approximately 12 cm×7 cm, for example.

The touchpad 10 is a pointing device that enables pointing operations to move the cursor using a human hand (including fingertips and pen tips). Pressing down on the sensor board 24 on the surface of the touchpad 10 switches an internal switch 32, thereby providing a click sensation. The sensor board 24 is capable of recognizing the contact position of the human hand. The touchpad 10 enables processing such as so-called right-click and left-click based on the position of the human hand when the sensor board 24 is pressed down. Furthermore, the touchpad 10 is able to respond to various operations such as tap, double-tap, two-finger tap, and pinch through software processing.

A rectangular pad hole 14b is formed on a surface 14a of the main body chassis 14, exposing the sensor board 24 through the pad hole 14b. The sensor board 24 is substantially an extension of the surface 14a. The switch 32 is a metal dome switch, a rubber dome switch, or the like. The touchpad 10 is able to be used as a plate-type pen tablet.

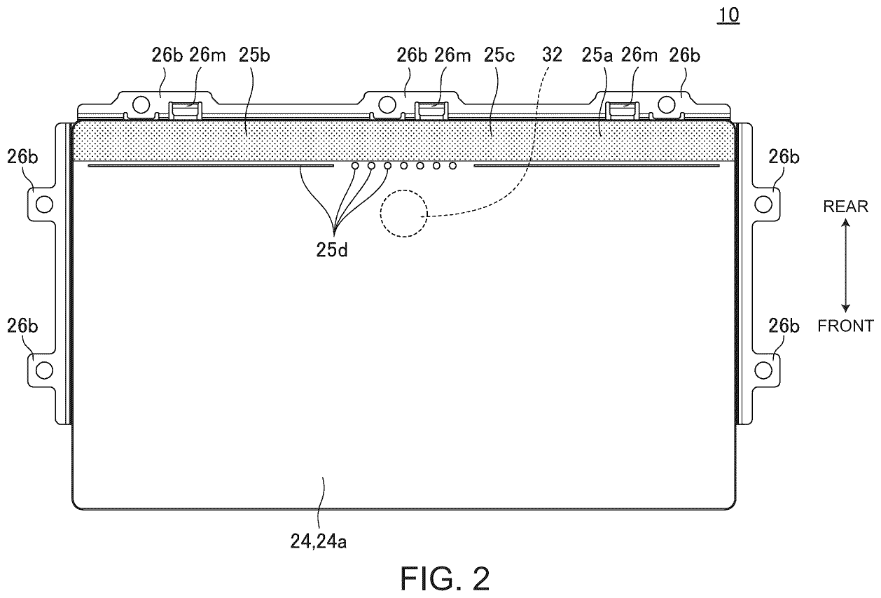

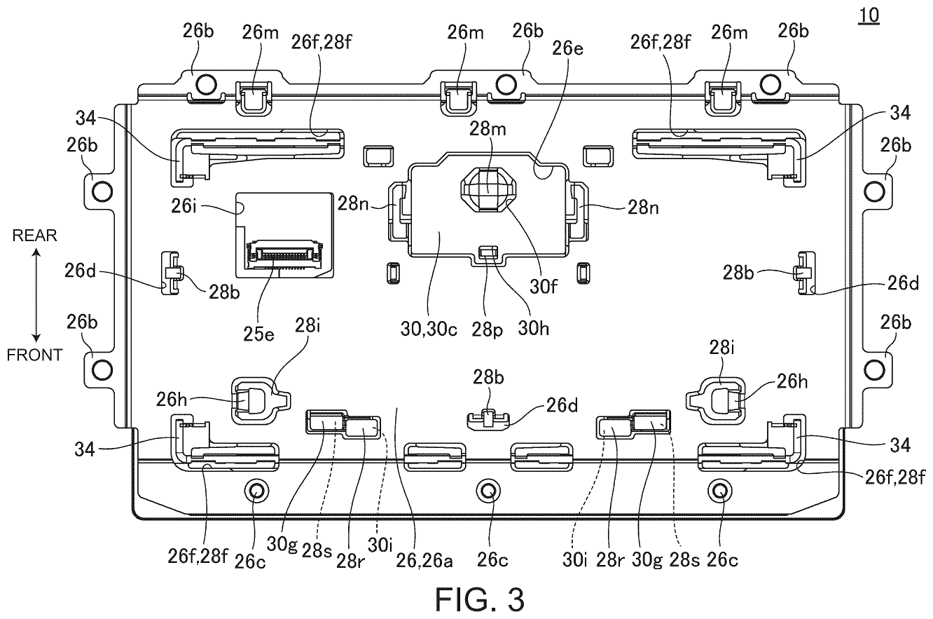

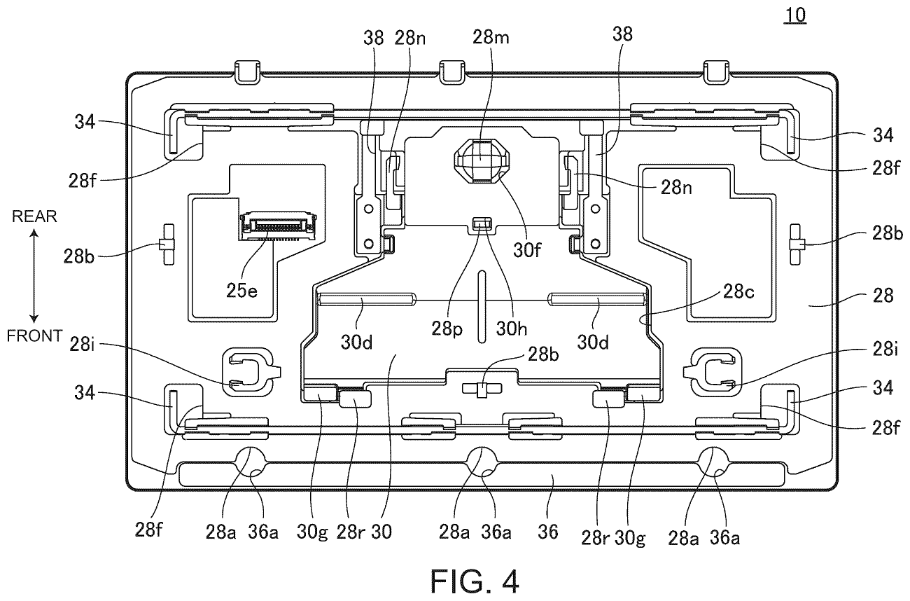

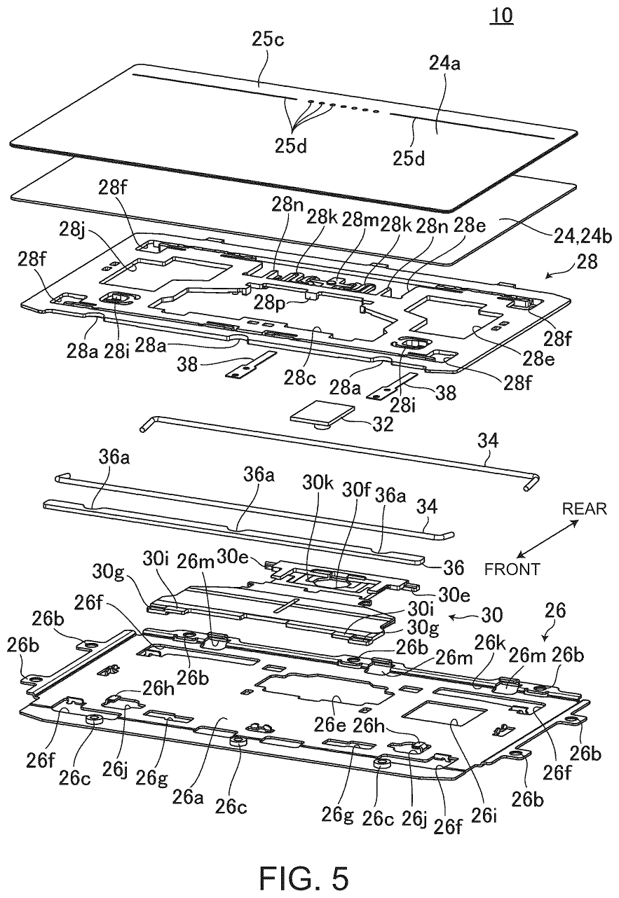

FIG. 2 is a plan view of the touchpad 10. FIG. 3 is a bottom view of the touchpad 10. FIG. 4 is a bottom view of the touchpad 10 with the base plate 26 removed. FIG. 5 is an exploded perspective view of the touchpad 10.

The touchpad 10 includes, in addition to the above-mentioned sensor board 24 and switch 32, a base plate 26, a housing plate (second tilting member) 28, a pusher plate (first tilting member) 30, two stabilizers 34, a stiffener 36, and two plate springs (elastic material) 38.

The sensor board 24 is sized to fit into the pad hole 14b described above and has a laminated structure of a glass 24a (see FIG. 5) having sensing functions such as electrostatic capacitive sensing and a printed circuit board 24b (see FIG. 5). A strip-shaped area along the rear edge on the upper surface of the sensor board 24 is set in the pseudo-button area 25. FIG. 2 illustrates the pseudo-button area with a dotted pattern. The pseudo-button area 25 is set with a narrow front-to-rear width sufficient for enabling a finger press operation. The pseudo-button area 25 is assigned to operations related to the pointing stick 22 and includes a slightly wider left-click portion 25a and a slightly wider right-click portion 25b on the left and right sides, and a narrower scroll portion 25c in the center. The scroll portion 25c is for scrolling web pages or documents in any direction. The pseudo-button area 25 is primarily operated with the thumb in combination with the pointing stick 22 and is separated from other areas by marks 25d such as lines or dots. Areas on the sensor board 24 other than the pseudo-button area 25 correspond to a normal pad area for cursor movement. Depending on the specifications, the pseudo-button area 25 may be provided along the front edge of the sensor board 24.

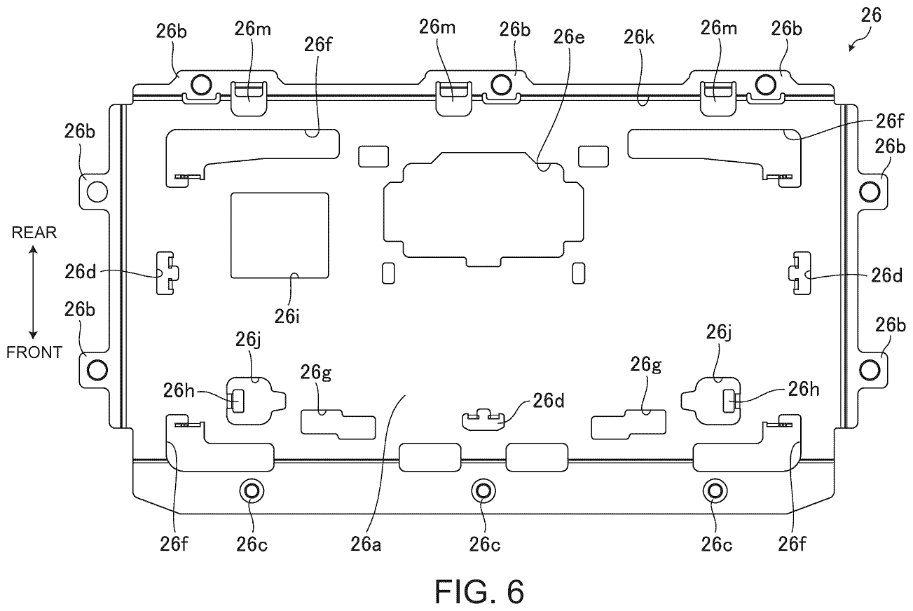

FIG. 6 is a plan view of the base plate 26. The base plate 26 is formed by press-working a metal plate and has a main body portion 26a of approximately the same size as the sensor board 24, two fixing tabs 26b provided on each of the left and right sides, three fixing studs 26c provided at the front, and one engagement hole 26d provided on each of the left and right sides and at the front, an approximately rectangular pusher operation hole 26e provided closer to the rear, L-shaped stabilizer operation holes 26f provided near the four corners, second pivot point holes 26g provided split left and right closer to the front, fork holes 26h provided split left and right closer to the front, and a connector hole 26i. The base plate 26 is fixed to the main body chassis 14 or a predetermined fixing target by the fixing tabs 26b and the fixing studs 26c. The fixing studs 26c are fixed to the base plate 26 by welding or the like. The connector 25e is exposed through the connector hole 26i. The connector 25e is provided on the rear surface of the sensor board 24. A small engagement piece 26j protrudes into a fork hole 26h. A step 26k is formed with the fixing tabs 26b at the rear edge and left and right edges of the main body portion 26a. Small anti-slip protrusions (anti-slip portions) 26m, directed forward, are provided on the upper edges of the left and right steps 26k. The anti-slip protrusions 26m restrict upward displacement of the housing plate 28, thereby serving as an anti-slip portion.

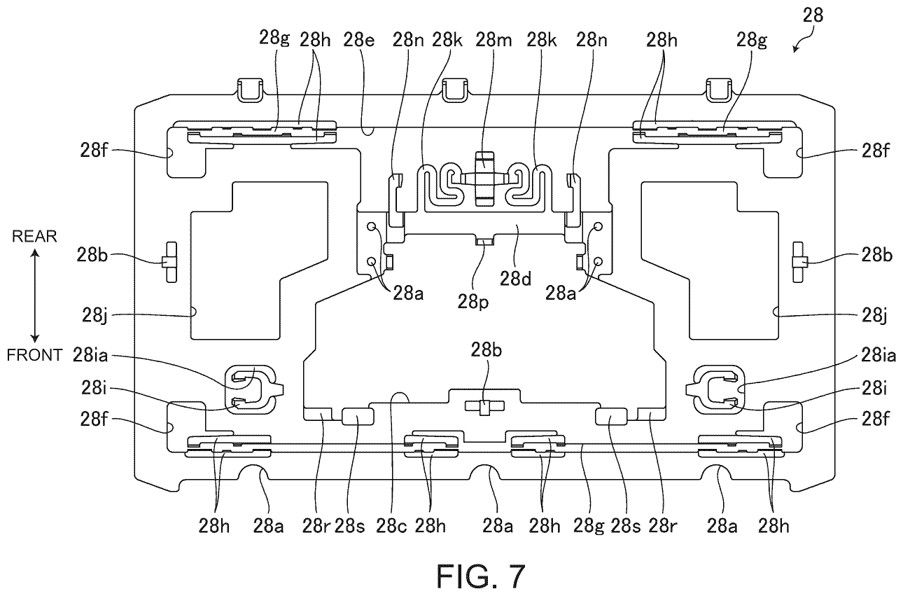

FIG. 7 is a plan view of the housing plate 28. The housing plate 28 is an injection-molded resin part, and has the same width as the sensor board 24 but a slightly shorter front-to-rear width. The housing plate 28 is fixed to the rear surface of the sensor board 24. The housing plate 28 aligns with the base plate 26 at the rear edge and the left and right edges, overlapping the main body portion 26a with the edges approximately positioned by the step 26k. The housing plate 28 has: three stud notches 28a provided at the front; engagement claws 28b provided three at the rear, one on each of the left and right sides, and one at the front; a plate hole 28c at the center; a pressure piece placement hole 28e adjacent to the rear via a bridge 28d relative to the plate hole 28c; L-shaped stabilizer operation holes 28f provided near the four corners; a stabilizer groove 28g formed between the left and right stabilizer operation holes 28f; a plurality of hooks 28h provided along the stabilizer groove 28g; a fork 28i split left and right closer to the front; and two left and right cutout holes 28j.

The stud notch 28a is semicircular and provides a positioning action by engaging with the fixing stud 26c. The engagement claws 28b (anti-slip portions) are each configured to engage with each of the engagement holes 26d. Engagement between the engagement claw 28b and the engagement hole 26d is designed not to impede the tilting motion of the housing plate 28. The plate hole 28c has a shape consisting of a flat rectangular portion extending left and right at the front combined with a flat trapezoidal portion at the rear.

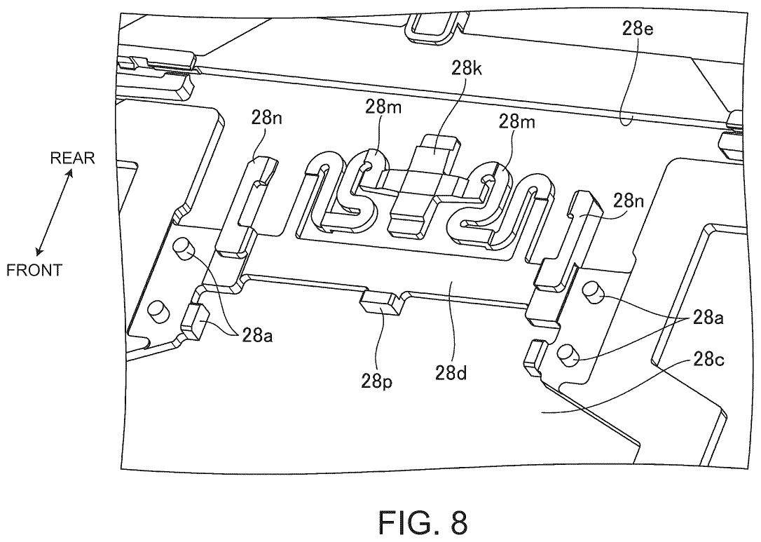

FIG. 8 is a perspective view of the pressure piece placement hole 28e and the surrounding area thereof. A pressure piece 28k is provided in the pressure piece placement hole 28e to press the switch 32. The pressure piece 28k is cross-shaped, with the left and right ends thereof supported by an elastic arm 28m. A low cylindrical protrusion is provided at the center of the upper surface of the pressure piece 28k, and this protrusion presses the switch 32. The elastic arm 28m is capable of elastic deformation due to having five curved portions, thereby supporting the pressure piece 28k to allow the pressure piece 28k to tilt in any direction, including forward, backward, left, and right. The pressure piece 28k is arranged slightly lower than other parts, such as the bridge 28d. The end of the elastic arm 28m is connected to the bridge 28d.

A stopper piece 28n protrudes from the bridge 28d toward the pressure piece placement hole 28e at a position adjacent to the elastic arm 28m. The stopper piece 28n limits the downward displacement of the pusher plate 30. Two welding posts 280 are provided on each side of the bridge 28d. The welding posts 280 are inserted into mounting holes of a plate spring 38 and welded, thereby fixing the plate spring 38. The position of the plate spring 38 is not limited to this location. A positioning protrusion 28p extends downward from the bridge 28d. The pressure piece placement hole 28e also functions as a stabilizer groove 28g.

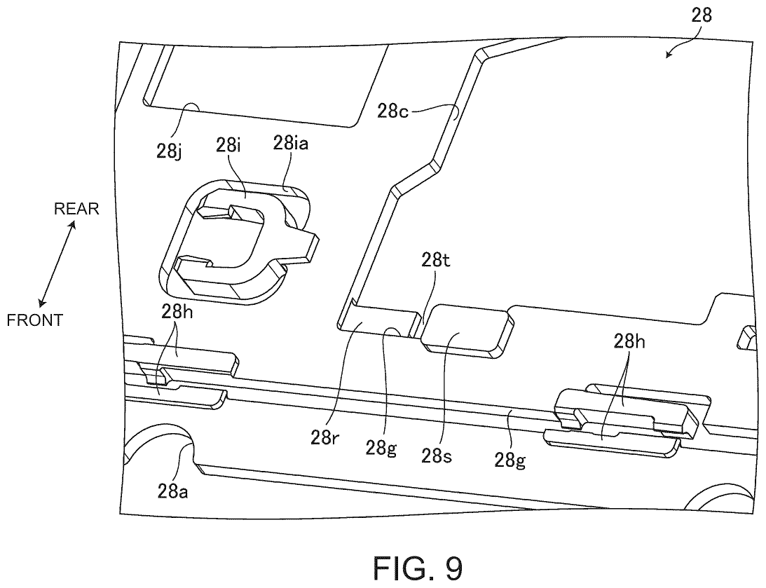

FIG. 9 is an enlarged perspective view of the front corner portion of the plate hole 28c as seen from below. The fork 28i is a substantially U-shaped portion formed within a fork placement hole 28ia. The fork 28i engages with the engagement piece 26j by entering the fork hole 26h, thereby providing a function to combine and prevent slippage of the housing plate 28 in the direction of stacking the housing plate 28 onto the base plate 26. The fork 28i is configured so as not to impede the tilting of the housing plate 28.

The recessed portions 28q at both ends of the front edge portion of the plate hole 28c have a first small protrusion 28r and a second small protrusion 28s formed, both protruding rearward. The first small protrusion 28r and the second small protrusion 28s are located in the positions deviated in the lateral direction and are adjacent to each other through a narrow gap 28t. The second small protrusion 28s is positioned closer to the center than the first small protrusion 28r. The second small protrusion 28s is positioned slightly lower than the first small protrusion 28r. The first small protrusion 28r and the second small protrusion 28s are integrally formed with the side walls of the recess portion 28q, providing high bending rigidity.

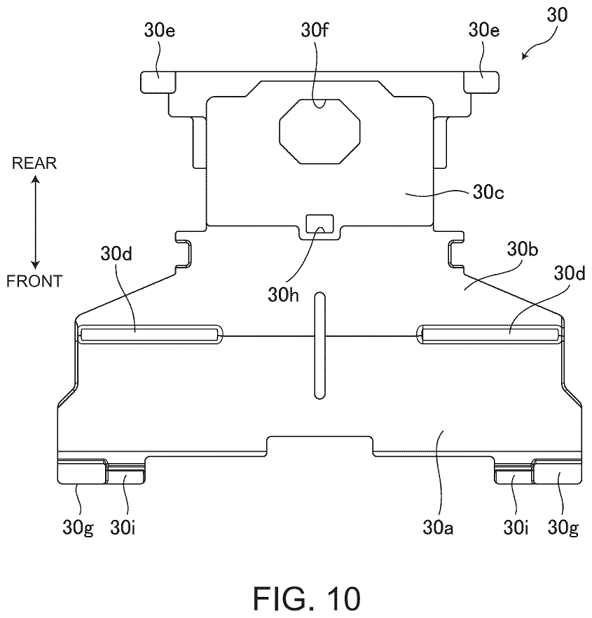

FIG. 10 is a bottom view of the pusher plate 30. The pusher plate 30 is an injection-molded resin part, having a shape consisting of a combination of: a front portion 30a, which is a flat rectangle extending left and right; an intermediate portion 30b, which is trapezoidal; and a rear portion 30c, whose width is an approximately half width of the front portion 30a. The front portion 30a and the intermediate portion 30b are shaped to fit precisely into the plate hole 28c. The rear portion 30c is positioned slightly lower than the front portion 30a and the intermediate portion 30b and does not interfere with the bridge 28d.

Two linear bulges 30d, divided left and right, are formed at the boundary between the front portion 30a and the intermediate portion 30b. The cross-section of the linear bulge 30d is semicircular and bulges low and downward. The linear bulges 30d are formed along the lateral direction, with each lateral width being approximately one-third of the front portion 30a. The linear bulge 30d abuts on the upper surface of the main body portion 26a of the base plate 26 to form the first pivot point 40 (see FIG. 12). The pusher plate 30 is configured to be tiltable clockwise and counterclockwise about the first pivot point 40. In the side view, the first pivot point 40 is located in a position deviated forward of the center C of the sensor board 24 (see FIG. 12), providing layout clearance for the switch 32 or the like in the area rearward of the first pivot point 40.

Spring retainers 30e protrude laterally from the rear end of the rear portion 30c. The plate spring 38 abuts on the spring retainers 30e, urging the rear portion 30c downward relative to the housing plate 28. In other words, the plate spring 38 urges the housing plate 28 and the pusher plate 30 so as to separate at the rear. The spring force of the plate spring 38 is set weakly enough to have almost no effect on manually pressing down the sensor board 24.

Furthermore, since the switch 32 also requires some force to press down, the switch 32 acts as an elastic material that biases the housing plate 28 and the pusher plate 30 apart. Therefore, depending on the specifications of the switch 32, the plate spring 38 may be omitted. The spring retainer 30e abuts on the upper surface of the base plate 26, thereby limiting the tilt angle of the pusher plate 30 and serving as an anti-slip portion.

An octagonal hole 30f is formed at a position slightly rearward on the rear portion 30c. On the upper surface of the rear portion 30c, a recess 30k (see FIG. 5), similar in shape to the octagonal hole 30f, is formed surrounding the octagonal hole 30f. The rear portion 30c serves as a mounting base for the switch 32, which is placed within the recess 30k and partially engaged within the octagonal hole 30f for positioning. A positioning hole 30h is formed at the boundary between the intermediate portion 30b and the rear portion 30c. The pusher plate 30 is positioned by inserting the positioning protrusion 28p into the positioning hole 30h.

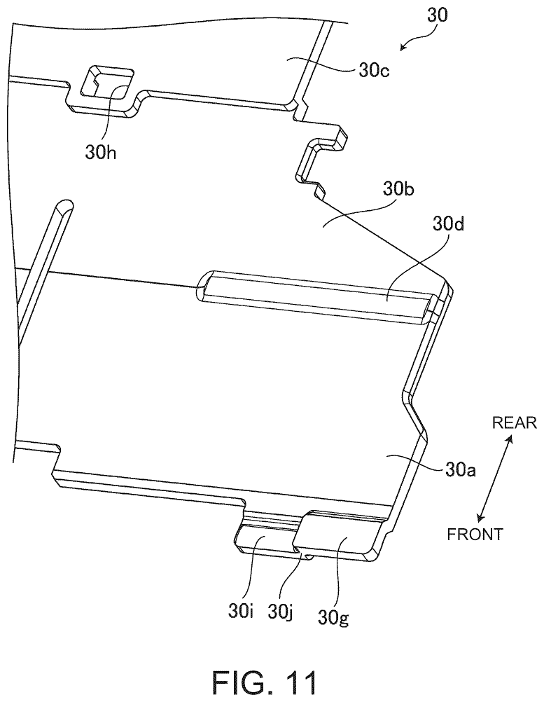

FIG. 11 is an enlarged perspective view of the front corner portion of the pusher plate 30, viewed from below. A third small protrusion 30g and a fourth small protrusion 30i, which protrude forward, are formed at both ends of the front edge portion of the pusher plate 30. The third small protrusion 30g and the fourth small protrusion 30i are adjacent to each other at positions deviated in the lateral direction and are connected by a thin vertical wall 30j. The fourth small protrusion 30i is located closer to the center than the third small protrusion 30g. The fourth small protrusion 30i is located slightly lower than the third small protrusion 30g. The third small protrusion 30g and the fourth small protrusion 30i are connected to each other by the vertical wall 30j, providing high bending rigidity.

The first small protrusion 28r and the third small protrusion 30g overlap vertically with almost no gap, and the second small protrusion 28s and the fourth small protrusion 30i overlap vertically with almost no gap, thereby forming a second pivot point 42 (see FIG. 12). The vertical wall 30j fits into the gap 28t. The housing plate 28 is positioned forward relative to the first pivot point 40 and is configured to be tiltable clockwise about the second pivot point 42 relative to the pusher plate 30.

The stabilizer 34 is a member made of a high-strength thin rod made of stainless steel or similar material, with both ends bent into an L-shape. The straight portion thereof fits into the stabilizer groove 28g and is secured against removal by the hook 28h. The bent ends of the stabilizer 34 are located within the stabilizer operation holes 26f and 28f. The stabilizer 34 is a stabilizing device that stabilizes forces acting on the sensor board 24 and the housing plate 28 in the lateral width direction, thereby suppressing the twisting and tilting thereof.

The stiffener 36 is a long plate-shaped member with three stud notches 36a formed on the rear edge. The stud notches 36a are semicircular and, when combined with the stud notches 28a, form a circle into which the fixing studs 26c fit. The stiffener 36 is fixed to the underside of the front edge of the sensor board 24, thereby reinforcing the sensor board 24.

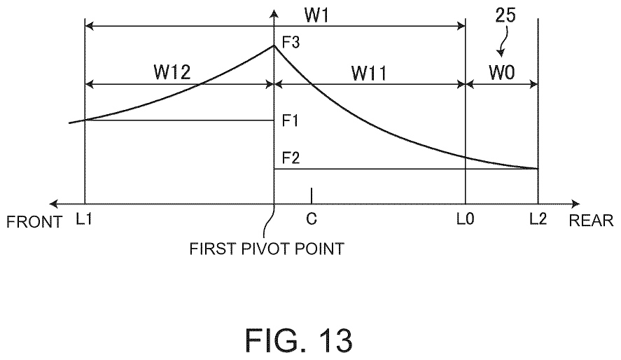

FIG. 12 is a schematic cross-sectional side view of the touchpad 10: (a) is a view illustrating a non-operational state; (b) is a view illustrating a state where the front end is pressed down; (c) is a view illustrating a state where the rear end is pressed down; (d) is a view illustrating a state where the touchpad is pressed down from above the first pivot point 40. FIG. 13 is a graph of a force required for pressing, measured by the inventor of the present invention on an actual touchpad 10 of one or more embodiments. The horizontal axis corresponds to the front-to-rear direction.

As described above, the pressure piece 28k of the housing plate 28 performs the press operation on the switch 32. FIG. 12, however, omits the pressure piece 28k and illustrates an operation being performed by the underside of the sensor board 24. Specifically, the switch 32 may be provided between the pusher plate 30 and either the housing plate 28 or the sensor board 24, located rearward of the first pivot point 40. The switch 32 may also be installed on the sensor board 24. The switch 32 need only be provided so as to be operated by pressing with being clamped between the pusher plate 30 and the housing plate 28 or the sensor board 24; it need not necessarily be fixed. In FIG. 12, the plate spring 38 is illustrated back to front.

As illustrated in FIG. 12 (a), during non-operation, the rear areas of the pusher plate 30 and the housing plate 28 are separated by the elastic force of the plate spring 38. The switch 32 located in this gap portion is in the off state. The rear end of the housing plate 28 contacts the anti-slip protrusion 26m. Furthermore, as described above, removal is prevented by engagement between the engagement claw 28b and the engagement hole 26d. The pusher plate 30 is in contact with the spring retainer 30e on the base plate 26. The sensor board 24 and the housing plate 28 are horizontal, while the pusher plate 30 is inclined slightly downward toward the rear with respect to the second pivot point 42.

As illustrated in FIG. 12 (b), pressing down on the front end of the sensor board 24 causes the housing plate 28 and the pusher plate 30 to tilt counterclockwise about the first pivot point 40. The pusher plate 30 approaches the underside of the housing plate 28 against the elastic force of the plate spring 38, thereby causing the gap between the pusher plate 30 and the housing plate 28 to be narrow. As a result, the switch 32 undergoes a press operation and turns on. At this time, a force F1 required to press down the sensor board 24 decreases in a manner approximately inversely proportional to the distance L1 from the first pivot point 40 (see FIG. 13).

As illustrated in FIG. 12 (c), pressing down on the rear end of the sensor board 24 maintains the orientation of the pusher plate 30, but the housing plate 28 tilts clockwise about the second pivot point 42. The sensor board 24 approaches the pusher plate 30 against the elastic force of the plate spring 38, narrowing the gap between the sensor board 24 and the pusher plate 30 and thereby causing the switch 32 to be pressed and enter the ON state. At this time, the force F2 required to press down the sensor board 24 decreases in a manner approximately inversely proportional to a distance L2 from the first pivot point 40 (see FIG. 13). Since the first pivot point 40 is located in the position deviated forward of the center C, the distance L2 is maintained adequately large. Consequently, the force F2 becomes sufficiently small to meet design criteria, so as to be suitable for the thumb operation of the pseudo-button area 25.

As illustrated in FIG. 12 (d), pressing down on the area above the first pivot point 40 causes the housing plate 28 and the sensor board 24 to descend while maintaining a nearly horizontal state. The pusher plate 30 approaches the housing plate 28 against the elastic force of the plate spring 38, thereby causing the switch 32 to be pressed and enter the ON state. At this time, a force F3 required to press down the sensor board 24 becomes moderately large (see FIG. 13) since the so-called lever principle does not apply, so as to be suitable for operating areas other than the pseudo-button area 25.

As illustrated in FIG. 13, the sensor board 24 has a strip-shaped area along the rear edge thereof assigned as the pseudo-button area 25. The front-to-rear width thereof is denoted as W0, and the front end position thereof is denoted as L0. The pad area other than the pseudo-button area 25 corresponds to the area between L0 and L1, with the front-to-rear width thereof denoted as W1. The first pivot point 40 is provided approximately at the center in the front-to-rear direction of the pad area excluding the pseudo-button area 25. Specifically, the width W11 from the first pivot point 40 to L0 and the width W12 from the first pivot point 40 to L1 are approximately equal to each other: in one or more embodiments, W11=W12=W1/2. In other words, the first pivot point 40 is positioned at the approximate center of the pad area, which is frequently used. Therefore, the user obtains a reliable operating feel with a moderately strong pressing force F3. Moreover, this provides an operating feel sufficiently distinct from the pressing force F2 required for the pseudo-button area 25. Note that “approximate center” refers to the position perceived as the center when the user operates the pad area with a finger.

As described above, the touchpad 10 of one or more embodiments has a configuration allowing the pusher plate 30 to tilt about the first pivot point 40, the housing plate 28 to tilt relative to the pusher plate 30 about the second pivot point 42 located on the front side, and the switch 32 to be provided on the rear side between the pusher plate 30 and either the housing plate 28 or the sensor board 24, thereby enabling the force required for pressing down to vary according to the operating area. The tilt references for the members of the touchpad 10 are sufficiently provided by just two points: the first pivot point 40 and the second pivot point 42. The first pivot point 40 and the second pivot point 42 are aligned in the lateral direction, facilitating design and verification for setting the front-to-rear pressing force.

The first pivot point 40 is located in the position deviated forward of the center C of the sensor board 24, allowing the force required for pressing to be set asymmetrically in the front-to-rear direction. This also provides space to arrange the switch 32 rearward.

The first pivot point 40 is formed where the linear bulge 30d formed on the pusher plate abuts on the base plate 26. This is a simple structure that requires no shaft members, has no rotating sliding parts, and is easy to assemble. The linear bulge 30d need not be linear; for example, a plurality of point-like bulges may be arranged side-by-side. The linear bulge 30d only need be formed on either the base plate 26 or the pusher plate 30, abutting on the other member.

The second pivot point 42 is configured such that the first small protrusion 28r and the third small protrusion 30g overlap vertically with almost no gap, and the second small protrusion 28s and the fourth small protrusion 30i overlap vertically with almost no gap. This is a simple structure that requires no shaft members, having no rotating sliding part, and is easy to assemble.

The switch 32 is pressed by the pressure piece 28k, supported by the elastic arm 28m from opposing left and right directions (two directions). This prevents excessive force from being applied and ensures balanced pressing. The housing plate 28 and the pusher plate 30 need not necessarily be plate-shaped; the housing plate 28 and the pusher plate 30 may, for example, have frame structures.

The present invention is not limited to the above-described embodiments, and naturally various modifications may be made without departing from the spirit of the present invention.

### DESCRIPTION OF SYMBOLS

10 touchpad
12 electronic apparatus
22 pointing stick
24 sensor board
25 pseudo-button area
26 base plate
28 housing plate (second tilting member)
28k pressure piece
28m elastic arm
28r first small protrusion
28s second small protrusion
30 pusher plate (first tilting member)
30d linear bulge (bulge)
30g third small protrusion
30i fourth small protrusion
32 switch
34 stabilizer
36 stiffener
38 plate spring (elastic material)
40 first pivot point
42 second pivot point

What is claimed is:

1. A touchpad comprising:
a base member;
a sensor board capable of recognizing a contact position;
a first tilting member configured to be tiltable about a first pivot point relative to the base member;
a second tilting member configured to be tiltable about a second pivot point relative to the first tilting member in a first direction as viewed from the first pivot point in side view, the second tilting member fixed to the sensor board;
an anti-slip portion of the first tilting member and the second tilting member for the base member;
an elastic material biasing the first tilting member and the second tilting member to separate in a second direction opposite to the first direction in side view; and
a switch configured between the first tilting member and either the second tilting member or the sensor board in the second direction as viewed from the first pivot point in side view.

2. The touchpad according to claim 1, wherein the first pivot point is located in a position deviated in the first direction from a center of the sensor board in side view.

3. The touchpad according to claim 1, wherein:
the base member and the first tilting member are plate-shaped; and
the first pivot point is formed where a bulge formed on one of the base member and the first tilting member abuts on the other one of the base member and the first tilting member.

4. The touchpad according to claim 1, wherein:
the first tilting member and the second tilting member are plate-shaped;
the second tilting member has a plate hole formed therein, into which a part of the first tilting member fits;
a first small protrusion is formed in extending toward the second direction from the edge of the plate hole;
a second small protrusion is formed in a position deviated from the first small protrusion and below the first small protrusion;
a third small protrusion is formed in extending toward the first direction from the edge of the first tilting member;
a fourth small protrusion is formed in a position deviated from the third small protrusion and above the third small protrusion; and
the second pivot point is formed by the first small protrusion and the third small protrusion overlapping vertically with almost no gap and by the second small protrusion and the fourth small protrusion overlapping vertically with almost no gap.

5. The touchpad according to claim 1, wherein:
the switch is located on one of the first tilting member and the second tilting member;
the other one of the first tilting member and the second tilting member includes a pressure piece supported by elastic arms from two opposing directions; and
the pressure piece is configured to press the switch.

6. The touchpad according to claim 1, wherein:
the touchpad is located on an upper surface of a chassis of an electronic apparatus, the touchpad being adjacent to a keyboard of the electronic apparatus in a front-to-rear direction; and
a press-down force of the sensor board varies along the front-to-rear direction.

7. The touchpad according to claim 6, wherein:
the keyboard includes a pointing stick to move a cursor displayed on a display of the electronic apparatus in a tilt direction; and
a strip-shaped area on the sensor board near the keyboard is assigned to an operation associated with the pointing stick.

8. The touchpad according to claim 6, wherein:
the sensor board has a strip-shaped area along a rear edge or a front edge, the strip-shaped area assigned as a pseudo-button area; and
the first pivot point is located approximately at a center, in the front-to-rear direction, of an area excluding the pseudo-button area.
